(19) United States
(12) Patent Application Publication
(10) Pub. No.: US 2024/0351041 A1
(43) Pub. Date: Oct. 24, 2024

(54) SYSTEMS AND METHODS FOR REAGENT STORAGE

(71) Applicant: 10x Genomics, Inc., Pleasanton, CA (US)

(72) Inventors: Cheyenne CHRISTOPHERSON, San Ramon, CA (US); Justin COSTA, Union City, CA (US); Shalini GOHIL, Wellesley, MA (US); Hong CHEN, Fremont, CA (US); Yufeng QIAN, Union City, CA (US); Minkyung PARK, Dublin, CA (US); Xiaoyang CAI, Dublin, CA (US); Hiroshi SASAKI, Dublin, CA (US); Naveed BAKH, Dublin, CA (US)

(21) Appl. No.: 18/634,751

(22) Filed: Apr. 12, 2024

Related U.S. Application Data
(60) Provisional application No. 63/460,762, filed on Apr. 20, 2023.

(51) Int. Cl. B01L 3/00

(52) U.S. Cl. CPC B01L 3/527; B01L 2200/025; B01L 2200/0689; B01L 2200/16; B01L 2300/044; B01L 2300/12

(57) ABSTRACT

The present disclosure provides systems and methods for reagent storage. System may include one or more substrates comprising a partition. The partition may be configured to retain a first reagent separate from a second reagent. The partition may include a seal disposed between the first and second reagent. The seal may be configured to maintain the first reagent separate from the second reagent. The first and second reagent may be disposed in a first layer and a second layer, respectively, of frozen material. The first layer and second layer of frozen material may maintain the first reagent separate from the second reagent.

### CROSS-REFERENCE

This application claims the benefit of U.S. Provisional Application No. 63/460,762, filed Apr. 20, 2023, which is entirely incorporated herein by reference.

### BACKGROUND

Working solutions may be useful in a variety of applications, such as for chemical or biological analysis or imaging. Working solutions may comprise multiple components (e.g., reagents) that are mixed together to create the working solution.

### SUMMARY

The present disclosure provides systems and methods for reagent storage. One or more components or reagents may be combined to generate a working solution. Individual components or reagents of a working solution may not be stable (e.g., activity or efficacy of the reagent may be reduced) when stored together. Storing reagents in multiple locations, containers, or packages may increase manufacturing complexity, packaging costs, and waste. Additionally, providing reagents in multiple packages may decrease assay efficiency and throughput. For example, combining multiple reagents into a single working solution from multiple packages or locations may rely on complex fluidics or a lab technician to prepare the working solution. The systems and methods described herein may provide for stable storage of multiple reagent components. The systems and methods described herein may provide for stratification and separation of incompatible reagents. The systems and methods described herein may decrease manufacturing complexity, packaging costs, and waste. The systems and methods described herein may be compatible with commercially available liquid handling systems, assay systems, etc. and may permit efficient, high throughput reagent preparation and use.

In an aspect, the present disclosure provides an assembly for storing reagents, comprising: a first substrate comprising a first partition configured to retain a first reagent, a second substrate comprising a second partition configured to retain a second reagent different than the first reagent, wherein the second substrate is coupled to the first substrate such that the second partition is aligned with the first partition; and a seal disposed between the first substrate and the second substrate, wherein the seal is configured (i) to seal an interface between the first partition or the second partition to maintain the first reagent separate from the second reagent and (ii) to be pierceable upon application of a force.

Provided herein is a system comprising any of the assemblies provided herein, wherein the assembly retains a first reagent and a second reagent in the first substrate and second substrate, respectively. In some embodiments, provided herein is a system, comprising a first substrate comprising a first partition and a second substrate comprising a second partition configured, wherein said second substrate is coupled to said first substrate such that said second partition is aligned with said first partition; and a seal disposed between said first substrate and said second substrate, wherein said seal is configured (i) to seal an interface between said first partition or said second partition to maintain said first reagent separate from said second reagent and (ii) to be pierceable upon application of a force; wherein said first substrate comprises a first reagent and said second substrate comprises a second reagent. In some embodiments, the first reagent or the second reagent comprises an enzyme. In some embodiments, the first reagent or the second reagent comprises one or more components selected from the group consisting of a cofactor, substrate, buffer, and combinations thereof. In some embodiments, the first reagent comprises an enzyme and the second reagent comprises a buffer. In some embodiments, the first reagent or the second reagent comprises protocatechuate-dioxygenase (PCD). In some embodiments, the first reagent comprises an enzyme and the second reagent comprises a cofactor of the enzyme. In some embodiments, the first substrate comprises a first plurality of partitions comprising the first partition and the second substrate comprises a second plurality of partitions comprising the second partition. In some embodiments, the seal is positioned between said first partition and said second partition.

In some embodiments, the first substrate comprises a first plurality of partitions comprising the first partition and the second substrate comprises a second plurality of partitions comprising the second partition. In some embodiments, the seal is configured to seal the interface between the first partition and the second partition. In some embodiments, the first partition is configured to retain a first liquid comprising the first reagent or the second partition is configured to retain a second liquid comprising the second reagent. In some embodiments, a seal between the first partition and the second partition is configured to retain the first liquid comprising the first reagent separate from the second liquid comprising the second reagent. In some embodiments, the first partition is configured to retain the first liquid comprising the first reagent and the second partition is configured to retain a second liquid comprising the second reagent. In some embodiments, the first reagent in the first liquid is hermetically sealed in the first partition or the second reagent in the second liquid is hermetically sealed in the second partition. In some embodiments, the first partition or the second partition is configured to retain a solid material comprising the first reagent or the second reagent.

In some embodiments, a force is required to pierce the seal between the first partition and the second partition. In some embodiments, the force is less than or equal to about 15 newtons (N). In some embodiments, the force is less than or equal to about 10 N. In some embodiments, the force is less than or equal to about 5 N. In some embodiments, the first partition comprises at least one side wall having a first end and a second end and an opening disposed adjacent to the first end or the second end, and wherein the first end has a first dimension and the second end has a second dimension. In some embodiments, the seal is in contact with the opening of the first partition. In some embodiments, the at least one sidewall is a circular frustum. In some embodiments, the first partition is a well. In some embodiments, the second partition is a well, and wherein a surface of the well comprises the seal. In some embodiments, the seal is substantially planar. In some embodiments, the second partition comprises at least one opening and at least one side wall having a first end and a second end, and wherein the first end has a first dimension and the second end has a second dimension. In some embodiments, the second partition comprises a first opening at the first end and a second opening at the second end. In some embodiments, the seal is in contact with the first opening of the second partition.

In some embodiments, the assembly further comprises an additional seal in contact with the second opening of the second partition, wherein the additional seal is configured to seal the second opening of the second partition. In some embodiments, the second partition is a channel. In some embodiments, the seal is a film. In some embodiments, the seal comprises a polymer. In some embodiments, the seal comprises aluminum. In some embodiments, the seal is an adhesive seal. In some embodiments, the adhesive seal comprises foil. In some embodiments, the adhesive seal comprises a double sided adhesive configured to couple the first substrate to the second substrate. In some embodiments, the seal is a heat seal. In some embodiments, the first substrate and the second substrate comprise mechanical fasters configured to couple the first substrate to the second substrate. In some embodiments, the first partition and the second partition have a total volume of less than or equal to about 2 milliliters (mL).

In another aspect, the present disclosure provides methods of using the assembly, comprising piercing the seal to permit the first reagent to mix with the second reagent.

In another aspect, the present disclosure provides an assembly for storing reagents, comprising: a substrate comprising a partition; a first layer of frozen material disposed in the partition, wherein the first layer of frozen material comprises a first reagent; and a second layer of frozen material disposed adjacent to the first layer of frozen material in the partition, wherein the second layer of frozen material comprises a second reagent different from the first reagent, and wherein the partition is configured to permit the first reagent and the second reagent to mix upon melting of the first layer of frozen material and the second layer of frozen material. In some embodiments, the first reagent or the second reagent comprises an enzyme. In some embodiments, the first reagent or the second reagent comprises one or more components selected from the group consisting of a cofactor, a substrate, a buffer, and combinations thereof. In some embodiments, the first reagent comprises an enzyme and the second reagent comprises a cofactor of the enzyme. In some embodiments, the first reagent comprises an enzyme and the second reagent comprises a buffer. In some embodiments, the first reagent or the second reagent comprises protocatechuate-dioxygenase (PCD).

In some embodiments, the substrate comprises a plurality of partitions comprising the partition. In some embodiments, the partition comprises at least one side wall having a first end and a second end and an opening disposed adjacent to the first end or the second end, and wherein the first end has a first dimension and the second end has a second dimension. In some embodiments, the at least one sidewall is a circular frustum. In some embodiments, the assembly further comprises a seal disposed in contact with the opening and configured to seal the partition. In some embodiments, the seal is configured to be pierceable by application of a force of less than or equal to about 15 N. In some embodiments, the force is less than or equal to about 10 N. In some embodiments, the force is less than or equal to about 5 N. In some embodiments, the assembly further comprises a third layer of frozen material disposed adjacent to the second layer of frozen material, wherein the third layer of frozen material comprises a third reagent different from the first reagent and the second reagent. In some embodiments, the partition is a well. In some embodiments, the partition has a volume of less than or equal to about 2 mL. In some embodiments, the partition has a volume of less than or equal to about 1 mL.

In another aspect, the present disclosure provides a method for using the assembly, comprising subjecting the partition to a temperature to melt the first layer of frozen material and the second layer of frozen material to permit the first reagent and the second material to mix.

In another aspect, the present disclosure provides a method for storing reagents, comprising: (a) providing (i) a first substrate comprising a first partition, (ii) a second substrate comprising a second partition, and (iii) a seal that is pierceable upon application of a force; (b) providing a first reagent to the first partition and a second reagent to the second partition; and (c) with the seal disposed between the first substrate and the second substrate, coupling the first substrate to the second substrate such that the first partition is aligned with the second partition, wherein the seal seals an interface between the first partition or the second partition to maintain the first reagent separate from the second reagent.

In some embodiments, the first substrate comprises a first plurality of partitions comprising the first partition and the second substrate comprises a second plurality of partitions comprising the second partition. In some embodiments, the seal seals the interface between the first partition and the second partition. In some embodiments, the first reagent or the second reagent is disposed in a liquid. In some embodiments, the first reagent and the second reagent are disposed in a liquid. In some embodiments, the method further comprises applying a force of less than or equal to about 15 N to the seal to pierce the seal and permit the first reagent to contact the second reagent. In some embodiments, the method further comprises aspirating the first reagent and the second reagent to mix the first reagent with the second reagent. In some embodiments, the force is less than or equal to about 10 N. In some embodiments, the force is less than or equal to about 5 N. In some embodiments, the first partition is a well. In some embodiments, the second partition is a well, and wherein a surface of the well comprises a pierceable seal.

In some embodiments, the second partition comprises a channel. In some embodiments, the second reagent is added to the second partition subsequent to coupling the first substrate to the second substrate such that the first partition is aligned with the second partition. In some embodiments, the first partition comprises at least one side wall having a first end and a second end and an opening disposed adjacent to the first end or the second end, and wherein the first end has a first dimension and the second end has a second dimension. In some embodiments, the second partition comprises at least one opening and at least one side wall having a first end and a second end, and wherein the first end has a first dimension and the second end has a second dimension. In some embodiments, the second partition comprises a first opening at the first end and a second opening at the second end, and wherein the seal is disposed in contact with the first opening. In some embodiments, the method further comprises applying an additional seal to the second opening to seal the second partition, wherein the additional seal is a pierceable seal. In some embodiments, the method further comprises hermetically sealing the first partition or the second partition. In some embodiments, the first partition and the second partition have a total volume of less than about 2 mL. In some embodiments, the first reagent or the second reagent is an enzyme. In some embodiments, the first reagent or the second reagent comprises one or more components selected from the group consisting of a cofactor, substrate, buffer, and combinations thereof.

In another aspect, the present disclosure provides method for storing reagents, comprising: (a) providing (i) a substrate comprising a partition, (ii) a first reagent in a first liquid material, and (iii) a second reagent different from the first reagent in a second liquid material; (b) providing the first reagent in the first liquid material to a partition of the plurality of partitions; (c) subjecting the first liquid material in the partition to a first temperature to generate a first layer of frozen material in the partition; (d) providing the second reagent in the second liquid material to the partition; and (e) subjecting the second liquid material in the partition to a second temperature to generate a second layer of frozen material in the partition, wherein the substrate is configured to permit the first reagent and the second reagent to mix upon melting of the first layer of frozen material and the second layer of frozen material.

In some embodiments, the substrate comprises a plurality of partitions comprising the partition. In some embodiments, the partition comprises at least one side wall having a first end and a second end and an opening disposed adjacent to the first end or the second end, and wherein the first end has a first dimension and the second end has a second dimension. In some embodiments, the method further comprises applying a seal to the opening to seal the partition. In some embodiments, the partition is hermetically sealed. In some embodiments, the seal is pierceable by a force of less than or equal to about 15 N. In some embodiments, the force is less than or equal to about 10 N. In some embodiments, the force is less than or equal to about 5 N.

In some embodiments, the first temperature is less than or equal to about 0° C. In some embodiments, the first temperature is less than or equal to about −20° C. In some embodiments, the first temperature is less than or equal to about −80° C. In some embodiments, the second temperature is less than or equal to about 0° C. In some embodiments, the second temperature is less than or equal to about −20° C. In some embodiments, the second temperature is less than or equal to about −80° C. In some embodiments, the method further comprises providing a third reagent in a third liquid material to the partition, wherein the third reagent is different from the first reagent and the second reagent. In some embodiments, the method further comprises subjecting the third liquid in the partition to a third temperature to generate a third layer of frozen material disposed adjacent to the second layer of frozen material in the partition. In some embodiments, the method further comprises reducing a temperature of the first liquid material or the second liquid material to a chilling temperature of less than or equal to about 5° C. prior to providing the first liquid material and the second liquid material to the partition. In some embodiments, the method further comprises subsequent to subjecting the second liquid material in the partition to a second temperature to generate a second layer of frozen material in the partition, subjecting the substrate to a melting temperature to melt the first layer of frozen material and the second layer of frozen material, wherein melting the first layer of frozen material and the second layer of frozen material permits the first reagent and the second reagent to mix. In some embodiments, the first reagent or the second reagent is an enzyme. In some embodiments, the first reagent or the second reagent comprises one or more components selected from the group consisting of a cofactor, substrate, buffer, and combinations thereof.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIGS. 1A and 1B schematically illustrates an example of an assembly and method for storing multiple reagents; FIG. 1A schematically illustrates an example of a storage method for a first reagent; FIG. 1B schematically illustrates an example of a storage method for a second reagent;

FIG. 2 shows a top down view of an example of a reagent storage system;

FIG. 3 schematically illustrates another example of an assembly and method for reagent storage;

FIG. 4 schematically illustrates an example method for combining separately stored reagents;

FIG. 5 schematically illustrates another example method for storing multiple reagents;

FIGS. 6A and 6B show example stability data of a pre-mixed working solution; FIG. 6A shows example stability data of a gassed and de-gassed imaging buffer; FIG. 6B show example kinetics data of a pre-mixed imaging buffer; and

FIG. 7 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

As used herein, the term “fluid” generally refers to a liquid or a gas. A fluid cannot maintain a defined shape and will flow during an observable time frame to fill the container into which it is put. Thus, the fluid may have any suitable viscosity that permits flow. If two or more fluids are present, each fluid may be independently selected among essentially any fluids (liquids, gases, and the like) by those of ordinary skill in the art.

As used herein, the term “partition” generally refers to a division into or distribution into portions or shares. For example, a partitioned sample is a sample that is isolated from other samples. Examples of structures that enable sample partitioning include wells and microchambers.

As used herein, the term “reagent” generally refers to any component, substance, or mixture usable for chemical or biological analysis. A reagent may be an enzyme, substrate, nucleic acid molecule, cofactor, inhibitor, ligand (e.g., biotin or hapten), probe, indicator, detectable moiety, catalyst, buffer, or any other component of a chemical or biological reaction. An indicator or detectable moiety may comprise any fluorophores, radioactive isotopes, fluorescers, chemiluminescers, chromophores, dyes, metal ions, metal sols, and the like. A reagent may comprise a single component or multiple components. A reagent may be provided in a fluid or solid form. In an example, a reagent is provided as a liquid. The liquid may be an aqueous liquid, non-aqueous liquid, or a neat liquid. In another example, a reagent is provided as a solid. The solid may be a crystalline, lyophilized, or amorphous solid. A reagent may be provided as part of a working solution.

Working solutions may be used for a variety of biological and chemical applications. For example, for chemical or biological analysis, sample imaging, etc. Working solutions may comprise multiple components or reagents. The individual reagents may or may not be stable when stored together. For example, the activity or efficacy of a reagent may be reduced when stored as a complete working solution. To avoid a reduction in stability or activity, individual reagents may be stored separately, for example, in individual tubes, blister packs, or other separate container. Storing individual reagents separately may increase manufacturing complexity, packaging costs, and waste. Storing individual reagents may decrease analysis efficiency, decrease throughput, and rely on complex fluidics. Alternatively, the present disclosure provides systems and methods for stratified and separate storage of reagents that may be unstable together in a single location (e.g., single partition). Stratified storage of reagents that are unstable together in a single location may reduce manufacturing complexity, improve packaging, reduce waste, and reduce fluidics complexity. Storing reagents that are incompatible together in a single location may also increase throughput (e.g., imaging throughput, assay throughput, etc.) of automated systems by reducing a number of reagent storage locations (e.g., on a cartridge, plate, etc.) used for an individual working solution.

### Systems and Assemblies for Reagent Storage

In an aspect, the present disclosure provides an assembly for storing reagents. In some embodiments, the assembly comprises a first substrate, a second substrate, and a seal.

In some aspects, the present disclosure provides a system comprising any of the assemblies provided herein and one or more reagents retained by the assembly. In some embodiments, provided herein is a system comprising a first reagent provided in a first substrate and a second reagent provided in a second substrate, wherein the second substrate is coupled to the first substrate such that the second partition is aligned with said first partition; and a seal is disposed between the first substrate and the second substrate. In some embodiments, the seal is configured to seal an interface between the first partition or the second partition to maintain the first reagent separate from the second reagent. In some embodiments, the seal is pierceable upon application of a force.

The first substrate may comprise a first partition, or a first plurality of partitions comprising the first partition, configured to retain a first reagent. The second substrate may comprise a second partition, or a second plurality of partitions, configured to retain a second reagent different than the first reagent. In some embodiments, the second substrate is coupled to the first substrate such that the second partition is aligned with the first partition. In some embodiments, the seal is disposed between the first and second substrates. The seal may be configured to seal an interface between the first partition or the second partition to maintain the first reagent separate from the second reagent. In some embodiments, the seal is configured to be pierceable upon application of a force.

In another aspect, the present disclosure provides an assembly for storing reagents. The assembly may comprise a substrate, a first layer of frozen material, and a second layer of frozen material. In some embodiments, the substrate comprises a partition, or a plurality of partitions comprising the partition. In some embodiments, the first layer of frozen material is disposed in the partitions. In some embodiments, the first layer of frozen material comprises a first reagent. In some embodiments, the second layer of frozen material is disposed adjacent to the first layer of frozen material. In some embodiments, the second layer of frozen material comprises a second reagent different than the first reagent. The partition may be configured to permit the first reagent and the second reagent to mix upon melting of the first layer of frozen material and the second layer of frozen material.

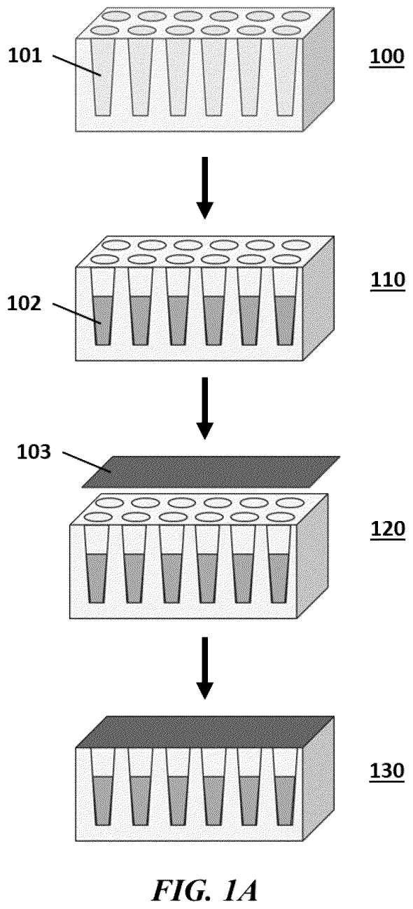

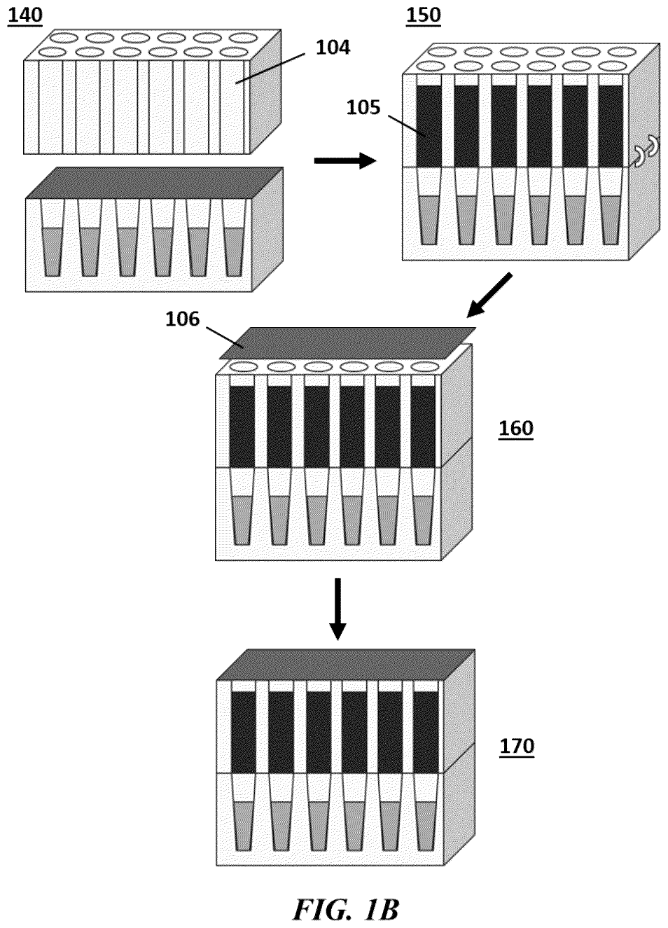

FIGS. 1A and 1B show an example assembly for storage of reagents. The assembly may have a first substrate and a second substrate. FIG. 1A shows an example of a first substrate. The first substrate may comprise a first partition 101 or a plurality of partitions 101. A partition 101 may be a well. The first partition 101 may be configured to retain a first reagent 102. The first substrate may further comprise a seal 103. The seal 103 may be disposed adjacent to a surface of the first substrate. The seal 103 may seal an opening of the partition 101. The seal may be a hermetic seal. FIG. 1B shows an example of a second substrate. The second substrate may comprise a second partition 104 or a plurality of partitions 104. The second substrate may be coupled to the first substrate. The first and second substrates may be coupled such that the first partition and second partition are aligned. The seal 103 may be disposed between the first substrate and the second substrate. The seal 103 may further seal the one end (e.g., an opening) of the second partition 104. The second partition 104 may be configured to retain a second reagent 105. The assembly may further comprise a second seal 106. The second seal 106 may seal the second partition 104.

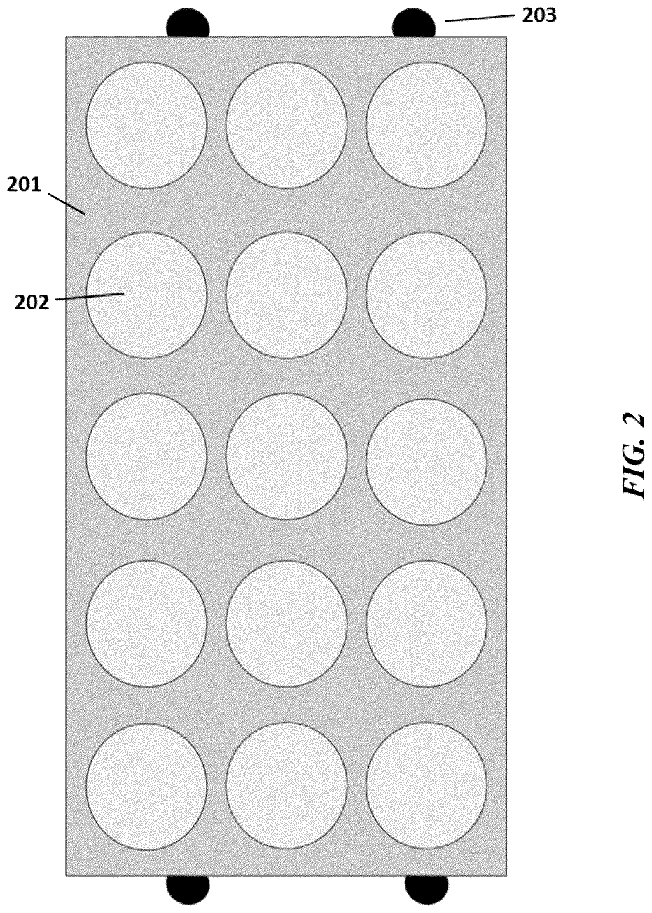

FIG. 2 shows a top down view of an example reagent storage assembly and seal. The assembly may include a partition or plurality of partitions with openings 202. The seal 201 may be disposed adjacent to and cover the opening(s) 202. The seal 201 may seal the opening(s) 202. In an example, the assembly comprises a single substrate. In another example, the assembly comprises a first substrate and a second substrate. The first substrate may be coupled to the second substrate. The first and second substrate may be coupled by an adhesive seal 201. Alternatively, or in addition to, the second substrate may be coupled to the first substrate by a mechanical fastener 203.

The assembly may include a single substrate or multiple substrates. The assembly may include at least one, two, three, four, five, or more substrates. In an example, the assembly includes a single substrate. In another example, the assembly includes two substrates. In another example, the assembly includes three substrates. A substrate may include a first, second, and third dimension. The first dimension may be a long dimension (e.g., length) of the substrate, the second dimension may be a width of the substrate, and the third dimension may be the height of the substrate. The first dimension may be less than or equal to about 50 centimeters (cm), 40 cm, 30 cm, 20 cm, 15 cm, 10 cm, or less. The second dimension may be less than or equal to about 20 cm, 15 cm, 10 cm, 8 cm, 6 cm, 4 cm, or less. The third dimension may be less than or equal to about 10 cm, 8 cm, 6 cm, 4 cm, 2 cm, or less. In an example, a substrate may have a first dimension of less than or equal to about 15 cm, a second dimension of less than or equal to about 10 cm, and a third dimension of less than or equal to about 6 cm. In an example, the substrate is configured to be workable with or may be workable with commercial liquid handlers, multiplate readers, sequencers, or other assay or diagnostic systems.

In some embodiments, the first substrate and second substrate have the same dimensions (e.g., length, width, and height). The first substrate and second substrate may have the same first dimension and second dimension, but may have different third dimensions (e.g., different heights). The third dimension of the total assembly (e.g., total height of the coupled substrates) may be less than or equal to about 10 cm, 8 cm, 6 cm, 4 cm, or less. In an example, the third dimension of the assembly is less than or equal to about 6 cm. The third dimension of the first substrate may be greater than the third dimension of the second substrate. The third dimension of the first substrate may be less than the third dimension of the second substrate. In an example, the assembly comprises three substrates comprising the same first, second, and third dimensions.

The first substrate, the second substrate, or both may comprise a plurality of partitions. The first substrate may have the same number of partitions as the second substrate. In assemblies comprising three substrates, the first, second, and third substrates may comprise the same number of partitions. The assembly may comprise greater than or equal to 5, 10, 50, 100, 200, 300, 400, 500, 600, 800, 1000, 1200, 1500, or more partitions. In an example, the assembly comprises greater than or equal to 50 partitions. In another example, the assembly comprises greater than or equal to about 300 partitions. In another example, the assembly comprises greater than or equal to about 1500 partitions. Each substrate may comprise the same number of partitions. Alternatively, or in addition two, different substrates may comprise a different number of substrates. The partitions of the first substrate may be aligned with the partitions of the second substrate. Assemblies comprising three or more substrates may comprise partitions aligned with the partitions of the first and second substrates.

The first partition may comprise at least one side wall having a first end and a second end. The first partition may comprise an opening disposed adjacent to the first end or the second end. The first end may have a first dimension and the second end may have a second dimension. The first dimension of the partition may be the same as the second dimension. The first dimension of the partition may be less than the second dimension. The first dimension of the partition may be greater than the second dimension. The first dimension or the second dimension of the partition may be less than or equal to about 20 millimeters (mm), 15 mm, 10 mm, 8 mm, 6 mm, 4 mm, 2 mm, or less. The at least one sidewall may form a circular frustum. The first partition may be a well. The well may comprise a round bottom, conical-shaped bottom, flat bottom, flat bottom with curved edges, or any other useful shape.

In some embodiments, the first substrate is disposed below the second substrate such that the first reagent is disposed below the second reagent along a vector normal to the gravitational force. Upon piercing a seal between the first and second reagent, the second reagent may be directed into the partition comprising the first reagent by gravity. Alternatively, or in addition to, an external force (e.g., pneumatic, vacuum, centrifugal force, etc.) may direct the second reagent into the partition comprising the first reagent.

In some embodiments, the seal is in contact with the opening of the first partition. The seal may contact and adhere to all edges of the opening such that the seal seals the opening. The seal may hermetically seal the opening.

The second partition may comprise at least one opening and at least one side wall having a first end and a second end. The first end and the second end may have a first dimension and a second dimension respectively. The second partition may comprise a first opening at the first end and a second opening at the second end. The seal may be in contact with the first opening of the second partition. The first dimension or the second dimension of the partition may be less than or equal to about 20 millimeters (mm), 15 mm, 10 mm, 8 mm, 6 mm, 4 mm, 2 mm, or less. The assembly may further comprise an additional seal in contact with the second opening of the second partition. The additional seal may be configured to seal the second opening of the second partition. The additional seal may be a pierceable seal. The additional seal may be similar to or substantially similar to the seal disposed between the first and second substrates. The second partition may be a well. A surface of the well (e.g., bottom of the well) may comprise the seal. The well may comprise a flat bottom. The second partition may be a channel. The channel may form a well when the first substrate is coupled to the second substrate.

In some embodiments, the seal is configured to seal an interface between the first partition and the second partition. In some embodiments, the seal is substantially planar. In some embodiments, the seal comprises a film. In some embodiments, the seal comprises a gasket or other material configured to maintain the first reagent and second reagent within the first and second partitions, respectively. The gasket may be a pressure type gasket that does not adhere to the first or second substrate. Alternatively, the gasket may adhere to the first or second substrate. In some embodiments, the seal comprises a polymer. The seal may comprise aluminum. The seal may be an adhesive seal. The adhesive seal may comprise foil. The adhesive seal may comprise a double sides adhesive configured to couple the first substrate to the second substrate. The seal may be a heat seal. The seal may contact and seal an edge of the opening of the first substrate and the second substrate. The seal may have a thickness of less than or equal to about 1 mm, 0.8 mm, 0.6 mm, 0.4 mm, 0.2 mm, 0.1 mm, 0.05 mm, 0.025 mm, or less. In assemblies comprising an additional seal configured to seal the second opening of the second substrate, the addition seal may have a thickness of less than or equal to about 1 mm, 0.8 mm, 0.6 mm, 0.4 mm, 0.2 mm, 0.1 mm, 0.05 mm, 0.025 mm, or less. The seal or additional seal may span the entire interfacial surface area between the first and second substrate. Alternatively, or in addition to, the assembly may comprise multiple seals disposed between the first and second substrate. Each seal may span a portion of the surface area between the first and second substrates.

In some embodiments, the first substrate and the second substrate comprises mechanical fasteners configured to couple the first substrate to the second substrate. The mechanical fasteners may be press fit, snap fit, interlocking features, screws, twist fit, compression fasteners, magnetic fasteners, or any other usable fasteners.

The assembly may include any number of substrates and seals such that each pair of substrates comprises a seal disposed therebetween. For example, the assembly may include three substrates and three seals. A first seal may be disposed between the first substrate and second substrate. A second seal may be disposed between the second substrate and the third substrate. The third seal may be disposed adjacent to an external surface of the third substrate to seal the third partition(s) of the third substrate.

In some embodiments, the first partition is configured to retain a first liquid comprising the first reagent. In some embodiments, the second partition is configured to retain a second liquid comprising the second reagent. The first partition may be configured to retain the first liquid comprising the first reagent and the second partition may be configured to retain the second liquid comprising the second reagent. The assembly may comprise a third, fourth, fifth, sixth, or more substrates. Each substrate may comprise a plurality of partitions. Each partition may be configured to retain an additional reagent separate from the first and the second reagents.

In some embodiments, provided herein is a system comprising a first substrate comprising a first reagent and a second substrate comprising a second reagent. In some embodiment, the first reagent or the second reagent comprises an enzyme. In some embodiments, the first reagent or the second reagent comprises one or more of cofactors, buffers, substrates, or any combination thereof. In some embodiments, the first or the second reagent, or both, may be usable as a working solution for imaging. Non-limiting examples of reagents usable in imaging may include phosphate-buffered saline (PBS), tris buffer, 1,4-diazabicyclo[2.2.2]octane (DABCO), 3,4-protocatechuic acid (PCA), protocatechuate-dioxygenase (PCD), glucose oxidase (GOx), pyranose oxidase (P2Ox), catalase, glucose, 6-hydroxy-2,5,7,8-tetramethylchroman-2-carboxylic acid (Trolox), or any combination thereof. In some embodiments, the PCD is bacterial protocatechuate 3,4-dioxygenase (rPCO). In some embodiments, the first reagent comprises an enzyme and the second reagent comprises a cofactor of the enzyme. In some embodiments, the first reagent comprises an enzyme and the second reagent comprises a buffer.

In some embodiments, the first reagent in the first liquid is hermetically sealed in the first partition. In some embodiments, the second reagent in the second liquid is hermetically sealed in the second partition. The first reagent may be hermetically sealed in the first partition and the second reagent in the second liquid may be hermetically sealed in the second partition. The assembly may comprise a third, fourth, fifth sixth, or more substrates. Each substrate may comprise a partition configured to retain an additional reagent. Each substrate may comprise a seal disposed between it and another substrate. The seal may be configured to hermetically seal the partition to retain the reagent within the partition.

In some embodiments, the first partition or the second partition is configured to retain a solid material comprising the first reagent or the second reagent. The first partition may be disposed beneath the second partition, for example, such that the second reagent is directed into the first partition upon piercing the seal. Upon piercing a seal disposed between the first partition and the second partition, the solid material comprising the second reagent may be directed via gravity into the first partition comprising the first reagent. In an example, the first reagent may be disposed in a liquid material and the liquid material may solubilize the second reagent upon contact with the second reagent. Any one of the first, second, third, fourth, or more reagents may be a solid or liquid reagent.

In some embodiments, the seal is configured to be pierceable by the application of a force. The seal may be configured to be pierceable upon the application of a force of greater than or equal to about 1 newton (N), 2 N, 3 N, 4 N, 5 N, 6 N, 7 N, 8 N, 10 N, 12 N, 15 N, or more. The seal may be configured to be pierceable upon application of a force of less than or equal to about 15 N, 12 N, 10 N, 8 N, 7 N, 6 N, 5 N, 4 N, 3 N, 2 N, 1 N, or less. In an example, the seal is pierceable by a force of less than or equal to about 15 N. In another example, the force is less than or equal to about 10 N. In another example, the force is less than or equal to about 5 N.

The first partition and the second partition may have a first volume and a second volume, respectively. The first substrate may comprise a plurality of partitions and the volume of the partitions may be the same across the substrate. Alternatively, or in addition to, the volume of the plurality of partitions may vary across the first substrate. The second substrate may comprise a plurality of partitions and the volume of the partitions may be the same across the substrate. Alternatively, or in addition to, the volume of the plurality of partitions may vary across the second substrate. The volume of the first partition may be less than, equal to, or greater than the volume of the second partition. In an example, the volume of the first partition is substantially the same as the volume of the second partition. The volume of the first partition may be 25%, 50%, 75%, 100%, 125%, 150%, 175%, or 200% of the volume of the second partition. The first and second partitions (or first, second, and third partitions) may have a combined or total volume of less than or equal to about 10 milliliters, 8 mL, 6 mL, 4 mL, 2 mL, 1 mL, 500 microliters (μL), 250 μL, 100 μL, or less. The first and second partitions (or first, second, and third partitions) may have a combined or total volume of greater than or equal to about 100 μL, 250 μL, 500 μL, 1 mL, 2 mL, 4 mL, 6 mL, 8 mL, 10 mL, or more. The first and second partitions (or first, second, and third partitions) may have a combined or total volume from about 100 μL to 250 μL, 100 μL to 500 μL, 100 μL to 1 mL, 100 μL to 2 mL, 100 μL to 4 mL, 100 μL to 6 mL, 100 μL to 8 mL, 100 μL to 10 mL, 250 μL to 500 μL, 250 μL to 1 mL, 250 μL to 2 mL, 250 μL to 4 mL, 250 μL to 6 mL, 250 μL to 8 mL, 250 μL to 10 mL, 500 μL to 1 mL, 500 μL to 2 mL, 500 μL to 4 mL, 500 μL to 6 mL, 500 μL to 8 mL, 500 μL to 10 mL, 1 mL to 2 mL, 1 mL to 4 mL, 1 mL to 6 mL, 1 mL to 8 mL, 1 mL to 10 mL, 2 mL to 4 mL, 2 mL to 6 mL, 2 mL to 8 mL, 2 mL to 10 mL, 4 mL to 6 mL, 4 mL to 8 mL, 4 mL to 10 mL, 6 mL to 8 mL, 6 mL to 10 mL, or 8 mL to 10 mL. In an example, the first partition and the second partition may have a total volume of less than or equal to about 2 mL.

The assemblies described herein may be used in any method described elsewhere herein. In an example, the method of using the assembly may comprise piercing the seal or seals to permit the first reagent to mix with the second reagent.

In some embodiments, the assembly comprises a substrate. In an example, the assembly comprises a single substrate. The substrate may comprise a single partition comprising the first reagent and the second reagent. The substrate may comprise a plurality of partitions comprising the first and second reagents. The partition may comprise a first reagent, second reagent, third reagent or more reagents. The partition may comprise greater than or equal to 2, 3, 4, 5, 6, 8, 10, 12 or more reagents. The reagents may be disposed in stratified layers of material such that each layer comprises a single reagent. Alternatively, or in addition to, a layer may comprise more than one reagent. A single layer may comprise multiple, compatible reagents. Different layers may comprise reagents that are incompatible with one another.

The partition may be a well or any other structure described elsewhere herein. The partition may have a flat bottom, u-shaped bottom, v-bottom, or any other shape described elsewhere herein. The partition may have a volume of less than or equal to about 10 milliliters, 8 mL, 6 mL, 4 mL, 2 mL, 1 mL, 500 microliters (μL), 250 μL, 100 μL, or less. The partition may have a volume of greater than or equal to about 100 μL, 250 μL, 500 μL, 1 mL, 2 mL, 4 mL, 6 mL, 8 mL, 10 mL, or more. The partition may have a volume from about 100 μL to 250 μL, 100 μL to 500 μL, 100 μL to 1 mL, 100 μL to 2 mL, 100 μL to 4 mL, 100 μL to 6 mL, 100 μL to 8 mL, 100 μL to 10 mL, 250 μL to 500 μL, 250 μL to 1 mL, 250 μL to 2 mL, 250 μL to 4 mL, 250 μL to 6 mL, 250 μL to 8 mL, 250 μL to 10 mL, 500 μL to 1 mL, 500 μL to 2 mL, 500 μL to 4 mL, 500 μL to 6 mL, 500 μL to 8 mL, 500 μL to 10 mL, 1 mL to 2 mL, 1 mL to 4 mL, 1 mL to 6 mL, 1 mL to 8 mL, 1 mL to 10 mL, 2 mL to 4 mL, 2 mL to 6 mL, 2 mL to 8 mL, 2 mL to 10 mL, 4 mL to 6 mL, 4 mL to 8 mL, 4 mL to 10 mL, 6 mL to 8 mL, 6 mL to 10 mL, or 8 mL to 10 mL. In an example, the partition may have a total volume of less than or equal to about 2 mL. In another example, the partition may have a total volume of less than or equal to about 1 mL.

In some embodiments, the first reagent is disposed in a first layer of frozen material disposed in a partition. In some embodiments, the second reagent is disposed in a second layer of frozen material disposed in the partition. In some embodiments, the assembly further comprises a third reagent. In some embodiments, the third reagent is disposed in a third layer of frozen material disposed adjacent to the second layer of frozen material disposed in the partition. The partition may comprise any number of reagents disposed in stratified layers of frozen material.

In some embodiments, the assembly further comprises a seal disposed adjacent to an external surface of the substrate. The partition, or plurality of partitions, may comprise a well or wells comprising openings. In some embodiments, the seal is disposed adjacent to the opening(s). In some embodiments, the seal is configured to seal or hermetically seal the partitions. In some embodiments, the seal is substantially planar. In some embodiments, the seal comprises a film. In some embodiments, the seal comprises a gasket or other material configured to maintain the first reagent and second reagent within the first and second partitions, respectively. The gasket may separate the first partition from the second partition and may seal the first partition from the second partition when a compressive force is applied to the gasket. The seal may comprise a polymer. The seal may comprise aluminum. In some embodiments, the seal is an adhesive seal. In some embodiments, the adhesive seal comprises foil. In some embodiments, the seal is a heat seal. The seal may have a thickness of less than or equal to about 1 mm, 0.8 mm, 0.6 mm, 0.4 mm, 0.2 mm, 0.1 mm, 0.05 mm, 0.025 mm, or less. The seal may be configured to be pierceable by the application of a force. The seal may be configured to be pierceable upon the application of a force of greater than or equal to about 1 N, 2 N, 3 N, 4 N, 5 N, 6 N, 7 N, 8 N, 10 N, 12 N, 15 N, or more. The seal may be configured to be pierceable upon application of a force of less than or equal to about 15 N, 12 N, 10 N, 8 N, 7 N, 6 N, 5 N, 4 N, 3 N, 2 N, 1 N, or less. In an example, the seal is pierceable by a force of less than or equal to about 15 N. In another example, the force is less than or equal to about 10 N. In another example, the force is less than or equal to about 5 N.

The assemblies described herein may be used in any method described elsewhere herein. In an example, methods of using the assembly may include subjecting a partition to a temperature to melt the first layer of frozen material and the second layer of frozen material to permit the first reagent and second reagent to mix.

### Methods for Reagent Storage

In another aspect, the present disclosure provides a method for storing reagents. The method may comprise providing (i) a first substrate comprising a first partition, (ii) a second substrate comprising a second partition, and (iii) a seal that is pierceable upon application of a force. The method may further comprise providing a first reagent to the first partition and a second reagent different from the first reagent to the second partition. The second reagent may be different than the first reagent. The method may further include coupling the first substrate to the second substrate with the seal disposed between the first and second substrates. The seal may seal and interface between the first partition or the second partition to maintain the first reagent separate from the second reagent. The first substrate and second substrate may be coupled such that the first partition is aligned with the second partition.

In another aspect, the present disclosure provides a method for storing reagents. The method may comprise providing (i) a substrate comprising a partition, (ii) a first reagent in a first liquid material, and (iii) a second reagent different from said first reagent in a second liquid material. The method may further comprise providing the first reagent in the first liquid material to a partition of the plurality of partitions and subjecting the first liquid material in the partition to a first temperature to generate a first layer of frozen material in the partition. The method may further include providing the second reagent in the second liquid material to the partition and subjecting the second liquid material the partition to a second temperature to generate a second layer of frozen material in the partition adjacent to the first layer of frozen material. The substrate may be configured to permit the first reagent and the second reagent to mix upon melting of the first layer of frozen material and the second layer of frozen material.

FIGS. 1A and 1B show an example assembly and method for reagent storage. The example method may be a sequential filing scheme in which the reagent is provided to the first substrate, the first and second substrates are coupled, and the second reagent is provided to the second substrate. As shown in FIG. 1A, the method may comprise providing 100 a first substrate. The first substrate may include a first partition 101 and the method may include providing 110 a first reagent 102 to the first partition 101 as shown in. The method may further comprise applying 120 a seal 103 to the first substrate. Applying the seal 103 to the first substrate may seal 130 the first substrate. The method may further include providing and coupling 140 a second substrate comprising a second partition 104 to the first substrate. The method may comprise providing 150 a second reagent 105 to the second partition 104. The method may further include applying 106 an additional seal 106 to the second substrate. The additional seal 106 may be disposed adjacent to an opening of the second partition 104 to seal 170 the second partition 104.

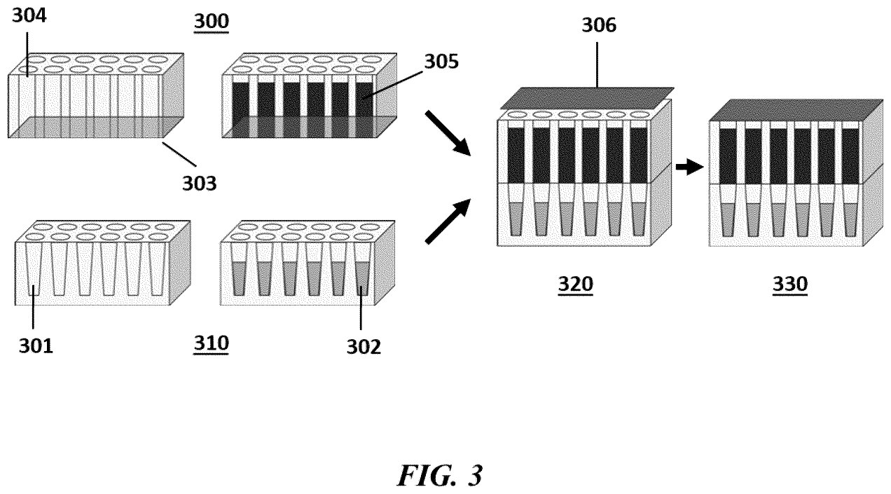

Alternatively, the first and second substrates may be filled prior to coupling the first as second substrate, as shown in FIG. 3. The first substrate and the second substrate may comprise a first 301 and second partition 304, or a first plurality of partitions and a second plurality of partitions, respectively. The first partition 301 may be a well. The second partition 301 may be a well with a pierceable bottom. Alternatively, the second partition 304 may comprise a channel with a pierceable seal 303 disposed adjacent to one of the openings of the channel. The first reagent 302 may be provided 310 to the first partition 301 simultaneously with providing 300 the second reagent 305 to the second partition 304. Alternatively, the first reagent 302 may be provided 310 to the second partition 301 sequentially with the second reagent 305 may be provided 300 to the second partition 304. Once the reagents are provided to the partitions, the first substrate and the second substrate may be coupled 320. The first substrate may be coupled to the second substrate via a seal disposed between the first and second substrates. Alternatively, or in addition to, the first substrate may be coupled to the second substrate using one or more mechanical fasteners. The method may further comprise applying 330 an additional seal 306 to a top surface of the assembly to seal the second partition(s).

The first substrate may comprise a first plurality of partitions comprising the first partition and the second substrate may comprise a second plurality of partitions comprising the second partition. The method may further comprise providing the first reagent to the first plurality of partitions and the second reagent to the second plurality of partitions. The first partition may comprise a well or other structure configured to retain the first reagent. The first reagent may be provided to the first partition and, subsequently, a seal may be applied to the first substrate to seal the first reagent within the partition(s). The second substrate may be provided to and coupled to the first substrate. The second substrate may be coupled to the first substrate by the seal (e.g., double sided adhesive seal) or by mechanical fasteners (e.g., press fit, twist fit, etc.). Subsequent to coupling the first and second substrate, the second reagent may be provided to the second partition. Alternatively, or in addition to, the second reagent may be provided to the second partition prior to coupling the first and second partitions.

The first partition and the second partition may have a first volume and a second volume, respectively. The first substrate may comprise a plurality of partitions and the volume of the partitions may be the same across the substrate. Alternatively, or in addition to, the volume of the plurality of partitions may vary across the first substrate. The second substrate may comprise a plurality of partitions and the volume of the partitions may be the same across the substrate. Alternatively, or in addition to, the volume of the plurality of partitions may vary across the second substrate. The volume of the first partition may be less than, equal to, or greater than the volume of the second partition. In an example, the volume of the first partition is substantially the same as the volume of the second partition. The volume of the first partition may be 25%, 50%, 75%, 100%, 125%, 150%, 175%, or 200% of the volume of the second partition. The first and second partitions (or first, second, and third partitions) may have a combined or total volume of less than or equal to about 10 milliliters, 8 mL, 6 mL, 4 mL, 2 mL, 1 mL, 500 μL, 250 μL, 100 μL, or less. The first and second partitions (or first, second, and third partitions) may have a combined or total volume of greater than or equal to about 100 μL, 250 μL, 500 μL, 1 mL, 2 mL, 4 mL, 6 mL, 8 mL, 10 mL, or more. The first and second partitions (or first, second, and third partitions) may have a combined or total volume from about 100 μL to 250 μL, 100 μL to 500 μL, 100 μL to 1 mL, 100 μL to 2 mL, 100 μL to 4 mL, 100 μL to 6 mL, 100 μL to 8 mL, 100 μL to 10 mL, 250 μL to 500 μL, 250 μL to 1 mL, 250 μL to 2 mL, 250 μL to 4 mL, 250 μL to 6 mL, 250 μL to 8 mL, 250 μL to 10 mL, 500 μL to 1 mL, 500 μL to 2 mL, 500 μL to 4 mL, 500 μL to 6 mL, 500 μL to 8 mL, 500 μL to 10 mL, 1 mL to 2 mL, 1 mL to 4 mL, 1 mL to 6 mL, 1 mL to 8 mL, 1 mL to 10 mL, 2 mL to 4 mL, 2 mL to 6 mL, 2 mL to 8 mL, 2 mL to 10 mL, 4 mL to 6 mL, 4 mL to 8 mL, 4 mL to 10 mL, 6 mL to 8 mL, 6 mL to 10 mL, or 8 mL to 10 mL. In an example, the first partition and the second partition may have a total volume of less than or equal to about 2 mL. The first partition and the second partition may have a total volume of less than or equal to about 2 mL.

In some embodiments, the first partition, the second partition, or both is a well. The first partition may comprise at least one side wall having a first end and a second end and an opening disposed adjacent to the first end or the second end. The first end may have a first dimension and the second end may have a second dimension. The first partition may comprise an opening disposed adjacent to the first end or the second end. The first end may have a first dimension and the second end may have a second dimension. The first dimension of the partition may be the same as the second dimension. The first dimension of the partition may be less than the second dimension. The first dimension of the partition may be greater than the second dimension. In some embodiments, the first circumference of the partition may be greater than the second circumference. In some embodiments, the first circumference of the partition may be less than the second circumference. The first dimension or the second dimension of the partition may be less than or equal to about 20 millimeters (mm), 15 mm, 10 mm, 8 mm, 6 mm, 4 mm, 2 mm, or less. The at least one sidewall may form a circular frustum with a first and second circumference. In some embodiments, the first and second circumference are different. The first partition may be a well. The well may comprise a round bottom, conical-shaped bottom, flat bottom, flat bottom with curved edges, or any other useful shape.

In some embodiments, the second partition is a well or a channel. The second partition may comprise at least one opening and at least one side wall having a first end and a second end. The first end may have a first dimension and the second end may have a second dimension. The first dimension or the second dimension of the partition may be less than or equal to about 20 millimeters (mm), 15 mm, 10 mm, 8 mm, 6 mm, 4 mm, 2 mm, or less. In some embodiments, the second partition is a well and a surface of the well may comprise a pierceable seal. In some embodiments, the seal is disposed adjacent to an opening adjacent to the first end. In an example, the first partition is a well and the second partition is a well. In another example, the first partition is a well and the second partition is a channel. In an example, the second partition is a channel and the method comprises providing the first reagent to the first partition, applying a seal between the first substrate and the second substrate to seal the opening of the first partition and an opening of the second partition, and providing the second reagent to the second partition. In some embodiments, the method additionally comprises providing an additional seal to the second opening of the second partition to hermetically seal the second partition. Alternatively, or in addition to, the method may comprise applying the seal to the first opening of the second partition, providing the first reagent to the first partition and the second reagent to the second partition, and coupling the first and second substrates. The method may further include applying another seal to the second opening of the second substrate to hermetically seal the second partition.

In some embodiments, the method comprises coupling the first substrate to the second substrate. In some embodiments, a seal is disposed between the substrates prior to coupling. The seal may seal an interface between the first partition or the second partition. Alternatively, or in addition to, the seal may seal an interface between the first partition and the second partition. The seal may be applied to the first substrate to seal the first partition or plurality of first partition and, subsequently, the second substrate may be coupled to the first substrate such that the seal is disposed between the first substrate and the second substrate. Alternatively, the seal may be applied to the second substrate to seal the first opening of the second partition. Subsequently, the first substrate may be coupled to the second substrate such that the seal is disposed between the first and second substrates.

The first reagent, the second reagent, or both may be provided in a liquid form. The liquid may be an aqueous liquid or, alternatively, the liquid may be a neat liquid. Alternatively, the first reagent, the second reagent, or both may be provided as a solid. In some embodiments, the method further comprises providing at least one of the first or second reagents as a solid or gas and dissolving or solubilizing the first or second reagent into a liquid.

In some embodiments, the first reagent, the second reagent, or both is provided to the first partition and the second partition, respectively, under an oxygen or oxygen free environment. In an example, the first or second reagent, or both, are provided to the first or second partition in an oxygen containing environment. In an example, the first or second reagent, or both, are provided the to the first and second partition under a nitrogen or argon blanket. In some embodiments, the first and second partitions is hermetically sealed under a nitrogen or argon blanket such that the reagents are stored in the absence of or substantial absence of oxygen. In an example, dissolved oxygen from the reagent is removed or replaced. Any suitable methods for replacing dissolved oxygen in the imaging buffer may be used. In another example, the reagent is sparged (e.g., with argon). In another example, one or more cycles of freeze-pump-thaw degassing is preformed, membrane degassing is performed, or degassing is performed using a vacuum. In another example, the headspace of the first and second partitions is argon flushed before sealing.

In some embodiments, the method further comprises applying an additional seal to the second opening of the second partition to seal the second partition. In some embodiments, the additional seal is a pierceable seal. The additional seal may be similar to or substantially similar to the seal disposed between the first and second substrates. The seal or additional seal may have a thickness of less than or equal to about 1 mm, 0.8 mm, 0.6 mm, 0.4 mm, 0.2 mm, 0.1 mm, 0.05 mm, 0.025 mm, or less.

In some embodiments, the method comprises providing the first reagent to the first partition and, subsequently, the first partition may be sealed by the seal. Subsequent to sealing the first partition, the second substrate may be coupled to the first partition. Subsequent to coupling the first substrate and the second substrate, the second reagent may be provided to the second partition. Alternatively, the second reagent may be added to the second partition prior to coupling the first substrate to the second substrate.

The method may include any number of substrates and seals such that each pair of substrates comprises a seal disposed therebetween. For example, the assembly may include three substrates and three seals. In some embodiments, a first seal is disposed between the first substrate and second substrate. In some embodiments, a second seal is disposed between the second substrate and the third substrate. In some embodiments, the third seal is applied to an external surface of the third substrate to seal the third partition(s) of the third substrate.

In some embodiments, the method comprises hermetically sealing the first partition or the second partition. In some embodiments, the first partition or the second partition is hermetically sealed under an oxygen-containing or oxygen-free environment. In an example, the first partition or the second partition, or both, are hermetically sealed in an oxygen containing environment. In another example, the first partition or second partition, or both, are hermetically sealed in an oxygen free environment. In some embodiments, the first partition, second partition, or both are hermetically sealed under an argon or nitrogen blanket. Alternatively, or in addition to, the first partition, second partition, or both may be hermetically sealed under vacuum.

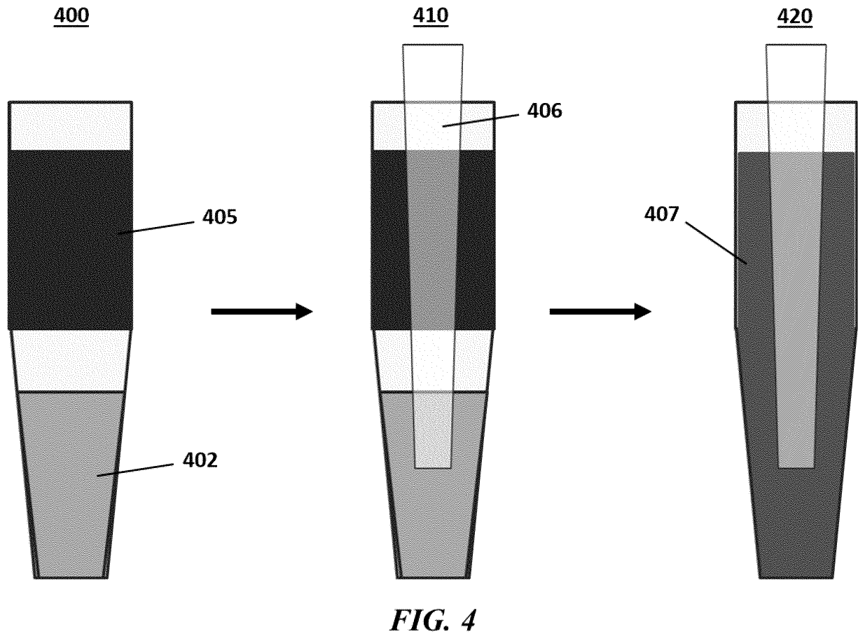

In some embodiments, the method further comprises applying a force to the seal to pierce the seal. Piercing the seal may permit the first reagent to contact and mix with the second reagent. FIG. 4 shows an example method comprising piercing 410 the seal and mixing the reagents 420 with a pipette 406. The method may include providing a substrate 400 or multiple substrates comprising a partition comprising first reagent 402 and a second reagent 405 separated by a seal. A pipette 406 may be inserted into the partition to pierce 410 the seal. Piercing 410 the seal may permit the reagents 402 and 405 to mix 420 to generate a mixed reagent 407.

In some embodiments, the method further comprises piercing the seal. The seal may be pierced by a force of greater than or equal to about 1 N, 2 N, 3 N, 4 N, 5 N, 6 N, 7 N, 8 N, 10 N, 12 N, 15 N, or more. The seal may be pierced by a force of less than or equal to about 15 N, 12 N, 10 N, 8 N, 7 N, 6 N, 5 N, 4 N, 3 N, 2 N, 1 N, or less. In an example, the seal is pierced by a force of less than or equal to about 15 Newtons (N). In another example, the seal is pierced by a force of less than or equal to about 10 N. In another example, the seal is pierced by a force of less than or equal to about 5 N. The seal and the additional seal may be pierced by the same force. The seal may be pierced by a pipette, needle, hollow tube, pin, or other physical implement. Alternatively, or in addition to, the seal may be pneumatically pierced.

In some embodiments, the method further comprises aspirating the first and second reagents together to mix the first reagent with the second reagent. The first and second reagents may be aspirated by a pipette, needle, hollow tube, or other implement usable for aspiration. The first reagent and the second reagent may be aspirated for at least about 1 second (s), 2 s, 5 s, 10 s, 20 s, 30 s, 45 s, 60 s, or more. The first and second reagent may be aspirated until the first and second reagent have fully mixed to generate a homogenous solution. In an example, the first and second reagents may be mixed by inversion (e.g., manual or instrumental inversion) to generate a sufficiently homogenous solution. Alternatively, in examples where the second reagent is provided as a solid, the first and second reagent may be aspirated until the second reagent is dissolved or solubilized in the first reagent. Methods for aspiration may be applied to assemblies comprising more than two substrates or more than two reagents (e.g., assemblies comprising 3, 4, 5, 6 or more reagents). In an example, a mixed reagent is formed comprising the first reagent and the second reagent and the method may comprise delivering a mixed reagent to a biological sample.

The methods described herein may be used with any of the assemblies also described elsewhere herein.

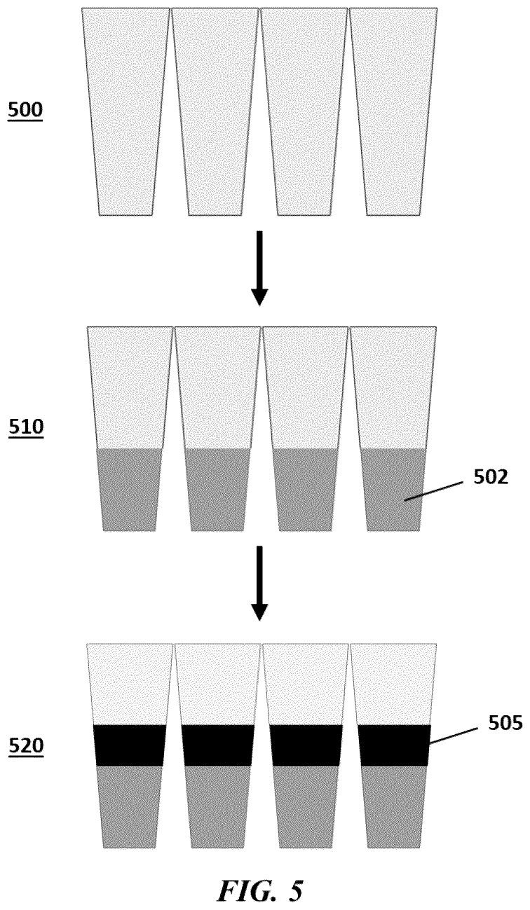

In some embodiments, the method comprises providing an assembly with a single substrate, as shown in FIG. 5. The method may comprise providing 500 a substrate comprising a partition or a plurality of partitions. A first reagent may be disposed in the partition, or plurality of partitions, and the partition may be subjected 510 to a temperature to generate a first layer of frozen material 502 comprising the first reagent. The method may further comprise providing a second reagent to the partition and subjecting 520 the partition to a temperature to generate a second layer of frozen material 505 disposed adjacent to the first layer of frozen material. In some embodiments, the two layers of frozen material maintain the first reagent separate from the second reagent.

The partition may comprise at least one side wall having a first end and a second end and an opening disposed adjacent to the first end or the second end. The first end may have a first dimension and the second end may have a second dimension. The first end may have a first dimension and the second end may have a second dimension. In some embodiments, the first dimension of the partition is the same as the second dimension. In some embodiments, the first dimension of the partition is less than the second dimension. In some embodiments, the first dimension of the partition is greater than the second dimension. The first dimension or the second dimension of the partition may be less than or equal to about 20 millimeters (mm), 15 mm, 10 mm, 8 mm, 6 mm, 4 mm, 2 mm, or less. The at least one sidewall may form a circular frustum. The first partition may be a well. The well may comprise a round bottom, conical-shaped bottom, flat bottom, flat bottom with curved edges, or any other useful shape.

In some embodiments, the method further comprises subjecting the first liquid material comprising the first reagent in the partition to a first temperature to generate a first layer of frozen material in the partition. The first temperature may be less than or equal to about 0° C., −10° C., −20° C., −40° C., −80° C., or less. The first temperature may be from about 0° C. to −10° C., 0° C. to −20° C., 0° C. to −40° C., 0° C. to −80° C., −10° C. to −20° C., −10° C. to −40° C., −10° C. to −80° C., −20° C. to −40° C., −20° C. to −80° C., −40° C. to −80° C. In an example, the first temperature is less than or equal to about 0° C. In another example, the first temperature is less than or equal to about −20° C. In another example, the first temperature is less than or equal to about −80° C. The first liquid material may be subjected to the first temperature for a time of greater than or equal to about 1 minute (min), 5 min, 10 min, 15 min, 20 min, 40 min, 60 min, 120 min, 240 min, or more.

The method may further include subjecting the second liquid material comprising the second reagent in the partition to a second temperature to generate a second layer of frozen material adjacent to the first layer of frozen material in the partition. The second temperature may be less than or equal to about 0° C., −10° C., −20° C., −40° C., −80° C., or less. The second temperature may be from about 0° C. to −10° C., 0° C. to −20° C., 0° C. to −40° C., 0° C. to −80° C., −10° C. to −20° C., −10° C. to −40° C., −10° C. to −80° C., −20° C. to −40° C., −20° C. to −80° C., −40° C. to −80° C. In an example, the second temperature is less than or equal to about 0° C. In another example, the second temperature is less than or equal to about −20° C. In another example, the second temperature is less than or equal to about −80° C. The second liquid material may be subjected to the second temperature for a time of greater than or equal to about 1 minute (min), 5 min, 10 min, 15 min, 20 min, 40 min, 60 min, 120 min, 240 min, or more.

In some embodiments, the method further comprises providing a third reagent in a third liquid material to the partition. In some embodiments, the third reagent is different from the first reagent and the second reagent. In some embodiments, the method further comprises subjecting the third liquid in the partition to a third temperature to generate a third layer of frozen material disposed adjacent to the second layer of frozen material in the partition. The third temperature may be less than or equal to about 0° C., −10° C., −20° C., −40° C., −80° C., or less. The third temperature may be from about 0° C. to −10° C., 0° C. to −20° C., 0° C. to −40° C., 0° C. to −80° C., −10° C. to −20° C., −10° C. to −40° C., −10° C. to −80° C., −20° C. to −40° C., −20° C. to −80° C., −40° C. to −80° C. In an example, the third temperature is less than or equal to about 0° C. In another example, the third temperature is less than or equal to about −20° C. In another example, the third temperature is less than or equal to about −80° C. The third liquid material may be subjected to the third temperature for a time of greater than or equal to about 1 minute (min), 5 min, 10 min, 15 min, 20 min, 40 min, 60 min, 120 min, 240 min, or more.

In some embodiments, the method further comprises reducing a temperature of the first liquid material or the second liquid material to a chilling temperature prior to providing the first liquid material or the second liquid material to the partition. The chilling temperature may be less than or equal to about 15° C., 10° C., 8° C., 6° C., 5° C., 4° C., 3° C., 2° C., 1° C., or less. In an example, the chilling temperature may be less than or equal to about 5° C. The first liquid material, second liquid material, or both, may be subjected to the chilling temperature for a time of greater than or equal to about 1 minute (min), 2 min, 5 min, 10 min, 15 min, 20 min, 40 min, 60 min, or more.

In some embodiments, the method further comprises applying a seal to the opening to seal the partition. Sealing the partition may hermetically seal the partition. In some embodiments, the seal is a pierceable seal. In some embodiments, the method further comprises piercing the pierceable seal. The seal may be pierced by a force of greater than or equal to about 1 N, 2 N, 3 N, 4 N, 5 N, 6 N, 7 N, 8 N, 10 N, 12 N, 15 N, or more. The seal may be pierced by a force of less than or equal to about 15 N, 12 N, 10 N, 8 N, 7 N, 6 N, 5 N, 4 N, 3 N, 2 N, 1 N, or less. In an example, the force applied to pierce the seal may be less than or equal to about 15 N. In another example, the force applied to pierce the seal may be less than or equal to about 10 N. In another example, the force applied to pierce the seal may be less than or equal to about 5 N.

The method may further comprise, subsequent to generating the first and second layer of frozen material and sealing the partition, subjecting the substrate to a melting temperature to melt the first layer of frozen material and the second layer of frozen material. Melting the first layer and second layer of frozen material may permit the first reagent and the second reagent to contact one another and mix. The melting temperature may be greater than or equal to about 0° C., 2° C., 4° C., 6° C., 8° C., 10° C., 15° C., 20° C., 25° C., 37° C., or higher. In an example, the melting temperature is about room temperature (e.g., approximately 20° C.). In some examples, the melting temperature is approximately 37° C. In another example, the melting temperature is about 4° C. The first and second layer of frozen material may be subjected to the melting temperature for greater than or equal to about 1 minute (min), 2 min, 5 min, 10 min, 15 min, 20 min, 40 min, 60 min, or more. The first and second layer of frozen material may be subjected to the melting temperature for greater than or equal to about 1 minute (min) to 10 minutes, about 1 minute (min) to 30 minutes, about 1 minute (min) to 60 minutes, about 10 minutes to 30 minutes, about 10 minutes to 60 minutes, about 20 minutes to 30 minutes, or about 20 minutes to 60 minutes. The first and second layer of frozen material may be subjected to a melting temperature of approximately 37° C. for greater than or equal to about 20 minutes or more. In some embodiments, the first and second layer of frozen material is subjected to the melting temperature in an air incubator or a water bath.

In some embodiments, the method further comprises piercing the seal. The seal may be pierce by applying a force as described elsewhere herein. The seal may be pierced before or subsequent to subjecting the first and second layers of frozen material to a melting temperature.

In some embodiments, the first reagent is different from the second reagent. The first or second reagent may be an enzyme, substrate, nucleic acid molecule, cofactor, inhibitor, ligand (e.g., biotin or hapten), probe, indicator, detectable moiety, catalyst, buffer, or any other component of a chemical or biological reaction. In some embodiments, the first reagent comprises an enzyme and the second reagent comprises a buffer. In some embodiments, the indicator or detectable moiety comprises any fluorophores, radioactive isotopes, fluorescers, chemiluminescers, chromophores, dyes, metal ions, metal sols, and the like. A reagent may comprise a single component or multiple components.

A fluorophore can comprise a substance or a portion thereof that is capable of exhibiting fluorescence in the detectable range. Particular examples of labels that may be used in accordance with the provided embodiments comprise, but are not limited to phycoerythrin, Alexa dyes, fluorescein, YPet, CyPet, Cascade blue, allophycocyanin, Cy3, Cy5, Cy7, rhodamine, dansyl, umbelliferone, Texas red, luminol, acradimum esters, biotin, green fluorescent protein (GFP), enhanced green fluorescent protein (EGFP), yellow fluorescent protein (YFP), enhanced yellow fluorescent protein (EYFP), blue fluorescent protein (BFP), red fluorescent protein (RFP), firefly luciferase, Renilla luciferase, NADPH, beta-galactosidase, horseradish peroxidase, glucose oxidase, alkaline phosphatase, chloramphenical acetyl transferase, and urease.

Examples of detectable moities comprise but are not limited to various radioactive moieties, enzymes, prosthetic groups, fluorescent markers, luminescent markers, bioluminescent markers, metal particles, protein-protein binding pairs and protein-antibody binding pairs. Examples of fluorescent proteins comprise, but are not limited to, yellow fluorescent protein (YFP), green fluorescence protein (GFP), cyan fluorescence protein (CFP), umbelliferone, fluorescein, fluorescein isothiocyanate, rhodamine, dichlorotriazinylamine fluorescein, dansyl chloride and phycoerythrin.

Examples of bioluminescent markers comprise, but are not limited to, luciferase (e.g., bacterial, firefly and click beetle), luciferin, aequorin and the like. Examples of enzyme systems having visually detectable signals comprise, but are not limited to, galactosidases, glucorimidases, phosphatases, peroxidases and cholinesterases. Identifiable markers also comprise radioactive compounds such as ¹²⁵I, ³⁵S, ¹⁴C, or ³H. Identifiable markers are commercially available from a variety of sources.

In some embodiments, the first reagent or the second reagent comprises an analyte binding moiety. An analyte binding moiety may include any molecule or moiety capable of binding to an analyte (e.g., a biological analyte, e.g., a macromolecular constituent). A labeling agent may include, but is not limited to, a protein, a peptide, an antibody (or an epitope binding fragment thereof), a lipophilic moiety (such as cholesterol), a cell surface receptor binding molecule, a receptor ligand, a small molecule, a bi-specific antibody, a bi-specific T-cell engager, a T-cell receptor engager, a B-cell receptor engager, a pro-body, an aptamer, a monobody, an affimer, a darpin, and a protein scaffold, or any combination thereof. In some embodiments, the labeling agents comprise (e.g., are attached to) a reporter oligonucleotide that is indicative of the cell surface feature to which the binding group binds.

An analyte binding moiety may include one or more antibodies or epitope-binding fragments thereof. The antibodies or epitope-binding fragments including the analyte binding moiety can specifically bind to a target analyte. In some embodiments, the analyte is a protein (e.g., a protein on a surface of the biological sample (e.g., a cell) or an intracellular protein).

In other instances, e.g., to facilitate sample multiplexing, a labeling agent that is specific to a particular cell feature may have a first plurality of the labeling agent (e.g., an antibody or lipophilic moiety) coupled to a first reporter oligonucleotide and a second plurality of the labeling agent coupled to a second reporter oligonucleotide.

The first reagent or the second reagent may be an enzyme. In some embodiments, the first reagent or the second reagent comprises one or more of cofactors, buffers, substrates, or any combination thereof. In an example, the first or the second reagent, or both, may be usable as a working solution for imaging. Non-limiting examples of reagents usable in imaging may include phosphate-buffered saline (PBS), tris buffer, 1,4-diazabicyclo[2.2.2]octane (DABCO), 3,4-protocatechuic acid (PCA), protocatechuate-dioxygenase (PCD), glucose oxidase (GOx), pyranose oxidase (P2Ox), catalase, glucose, 6-hydroxy-2,5,7,8-tetramethylchroman-2-carboxylic acid (Trolox), or any combination thereof. In some embodiments, the PCD is bacterial protocatechuate 3,4-dioxygenase (rPCO). In some embodiments, the first reagent comprises an enzyme that is activated once combined with the second reagent. In some embodiments, the first reagent comprises an enzyme that exhibits a reduction in activity once combined with the second reagent.

The first and second reagent may be mixed together. Mixing together the first and second reagents may generate a working solution. The working solution may be usable for sequencing, analyte detection, sample preparation, library generation, chemical or biological analysis, diagnostics, or any combination thereof. In some embodiments, the working solution may be usable as an imaging buffer.

The methods described herein may be used with any of the assemblies also described elsewhere herein.

### Computer Systems

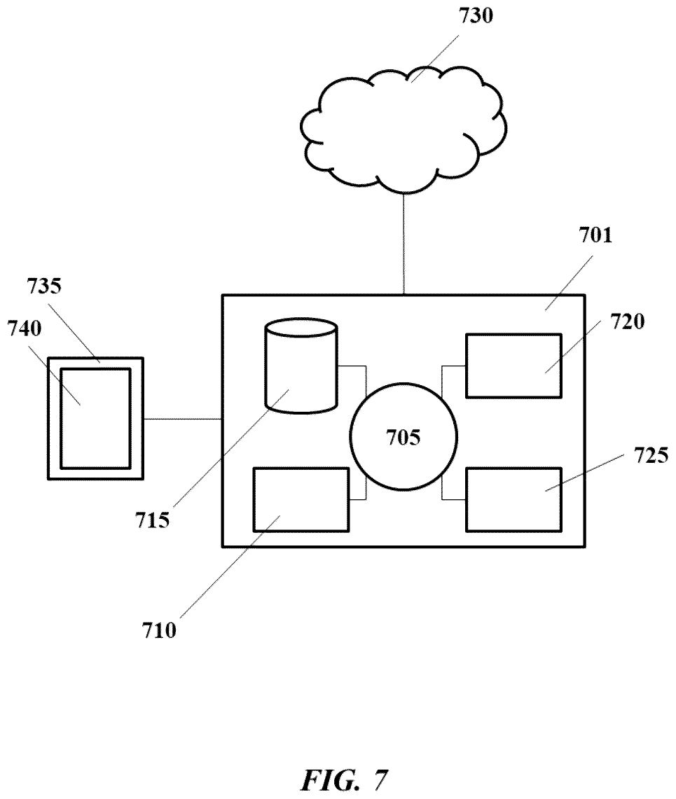

The present disclosure provides computer systems that are programmed to implement methods of the disclosure. FIG. 7 shows a computer system 701 that is programmed or otherwise configured to implement or otherwise automate methods for storing and/or using reagents. The computer system 701 can regulate various aspects of the systems and methods of the present disclosure, such as, for example, instructing a liquid handler to mix, aliquot, aspirate, and seal reagents for storage. In some embodiments, the computer system 701 can also direct various aspects of the systems and methods to deliver the reagent(s) to a biological sample. In some embodiments, the computer system 701 can also direct various aspects of the systems to mix two or more reagents. The computer system 701 can be connected to a liquid handler or system for sample processing by a wired connection or the computer system 701 may be an electronic device of a user remotely located with respect to the liquid hander or system for sample processor. The electronic device can be a mobile electronic device.

The computer system 701 includes a central processing unit (CPU, also “processor” and “computer processor” herein) 705, which can be a single core or multi core processor, or a plurality of processors for parallel processing. The computer system 701 also includes memory or memory location 710 (e.g., random-access memory, read-only memory, flash memory), electronic storage unit 715 (e.g., hard disk), communication interface 720 (e.g., network adapter) for communicating with one or more other systems, and peripheral devices 725, such as cache, other memory, data storage and/or electronic display adapters. The memory 710, storage unit 715, interface 720 and peripheral devices 725 are in communication with the CPU 705 through a communication bus (solid lines), such as a motherboard. The storage unit 715 can be a data storage unit (or data repository) for storing data. The computer system 701 can be operatively coupled to a computer network (“network”) 730 with the aid of the communication interface 720. The network 730 can be the Internet, an internet and/or extranet, or an intranet and/or extranet that is in communication with the Internet. The network 730 in some cases is a telecommunication and/or data network. The network 730 can include one or more computer servers, which can enable distributed computing, such as cloud computing. The network 730, in some cases with the aid of the computer system 701, can implement a peer-to-peer network, which may enable devices coupled to the computer system 701 to behave as a client or a server.

The CPU 705 can execute a sequence of machine-readable instructions, which can be embodied in a program or software. The instructions may be stored in a memory location, such as the memory 710. The instructions can be directed to the CPU 705, which can subsequently program or otherwise configure the CPU 705 to implement methods of the present disclosure. Examples of operations performed by the CPU 705 can include fetch, decode, execute, and writeback.

The CPU 705 can be part of a circuit, such as an integrated circuit. One or more other components of the system 701 can be included in the circuit. In some cases, the circuit is an application specific integrated circuit (ASIC).

The storage unit 715 can store files, such as drivers, libraries and saved programs. The storage unit 715 can store user data, e.g., user preferences and user programs. The computer system 701 in some cases can include one or more additional data storage units that are external to the computer system 701, such as located on a remote server that is in communication with the computer system 701 through an intranet or the Internet.

The computer system 701 can communicate with one or more remote computer systems through the network 730. For instance, the computer system 701 can communicate with a remote computer system of a user (e.g., liquid handler, system for sample processing, etc.). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 701 via the network 730.

Methods as described herein can be implemented by way of machine (e.g., computer processor) executable code stored on an electronic storage location of the computer system 701, such as, for example, on the memory 710 or electronic storage unit 715. The machine executable or machine-readable code can be provided in the form of software. During use, the code can be executed by the processor 705. In some cases, the code can be retrieved from the storage unit 715 and stored on the memory 710 for ready access by the processor 705. In some situations, the electronic storage unit 715 can be precluded, and machine-executable instructions are stored on memory 710.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 701, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 701 can include or be in communication with an electronic display 735 that comprises a user interface (UI) 740 for providing, for example, data related to preparing reagents for storage and reagent storage. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 705. The algorithm can, for example, execute processes for preparing, aliquoting, and storing reagents.

### EXAMPLES

### Example 1: Imaging Buffer Stability

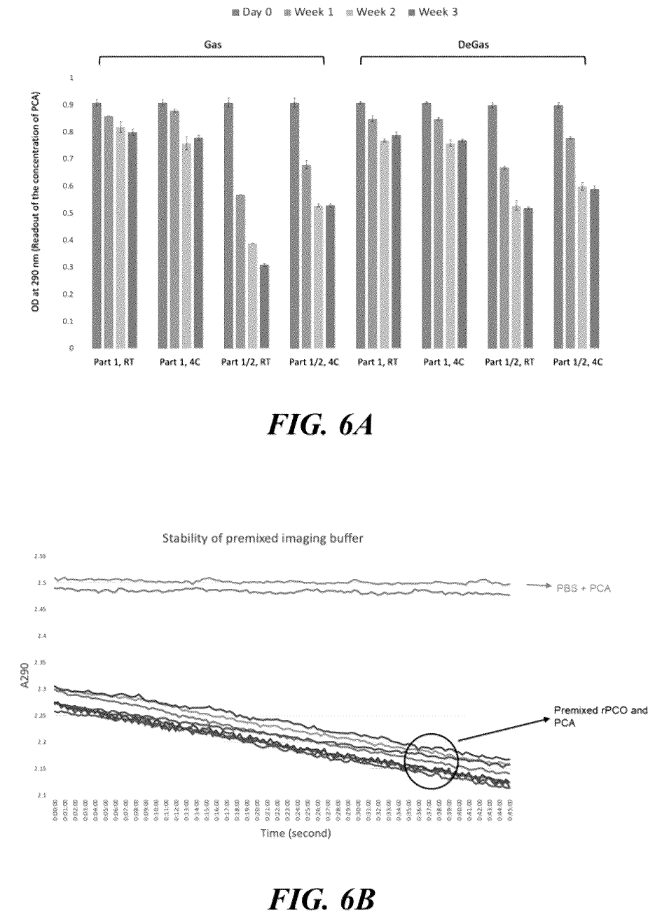

This example describes the testing of an imaging buffer comprising an enzyme that may be sensitive to conditions such as oxygen levels during manufacture and storage. A stability test was prepared using centrifuge tubes. A first set of centrifuge tubes was prepared with a first solution (part 1) comprising 50 millimolar (mM) 1,4-diazabicyclo[2.2.2]octane (DABCO), 20 mM 3,4-protocatechuic acid (PCA), and phosphate-buffered saline (PBS). A second set of centrifuge tubes was prepared with part 1 and a second solution (part 2) comprising 0.1875 units per milliliter (U/mL) protocatechuate-dioxygenase (PCD). A number of the first set and second set of centrifuge tubes were prepared in an oxygen free environment under an argon atmosphere. A number of the first set and second set of centrifuge tubes were prepared in an oxygen containing environment. The centrifuge tubes were stored at room temperature (RT), 4° C., and −20° C. The absorbance of the RT and 4° C. samples were measured at 290 nanometers (nm) every week, which shows a linear relationship to PCA concentration. The absorbance of the −20° C. samples were measured at 290 nm at various time points of up to the equivalent of 12 months. FIG. 6A shows example stability data for samples comprising part 1 and both part 1 and part 2 solutions stored at RT and 4° C. The degassed samples comprising both part 1 and part 2 showed a decrease in PCA concentration of 25% in one week. The shelf life of mixed part 1 and part 2 samples stored at −20° C. may be less than or equal to three months.

FIG. 6B shows example kinetic data of solutions comprising PBS and PCA (PCA solution) compared to premixed bacterial protocatechuate 3,4-dioxygenase (rPCO) and PCA solution (premixed solution). Both the PCA solution and premixed solution may be degassed or not prior to storage. Samples were stored at conditions that are equivalent to being stored at RT, 4° C., and −20° C. and tested. Premixed solutions comprising rPCO and PCA showed a decrease in PCA concentration (e.g., have a shorter shelf life) compared to tested control samples where PCA was stored in PBS. In some aspects, these results support the use of methods and assemblies for stable storage of individual components (e.g., reagents).

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-88. (canceled)

89. An assembly for storing reagents, comprising:
a first substrate comprising a first partition configured to retain a first reagent;
a second substrate comprising a second partition configured to retain a second reagent different than said first reagent, wherein said second substrate is coupled to said first substrate such that said second partition is aligned with said first partition; and
a seal disposed between said first substrate and said second substrate, wherein said seal is configured (i) to seal an interface between said first partition or said second partition to maintain said first reagent separate from said second reagent and (ii) to be pierceable upon application of a force.

90. The assembly of claim 89, wherein said first substrate comprises a first plurality of partitions comprising said first partition and said second substrate comprises a second plurality of partitions comprising said second partition.

91. The assembly of claim 89, wherein said first partition is configured to retain said first liquid comprising said first reagent and said second partition is configured to retain a second liquid comprising said second reagent.

92. The assembly of claim 89, wherein said first reagent in said first liquid is hermetically sealed in said first partition or said second reagent in said second liquid is hermetically sealed in said second partition.

93. The assembly of claim 89, wherein said first partition or said second partition is configured to retain a solid material comprising said first reagent or said second reagent.

94. The assembly of claim 89, wherein said first partition comprises at least one side wall having a first end and a second end and an opening disposed adjacent to said first end or said second end, and wherein said first end has a first dimension and said second end has a second dimension and said seal is in contact with said opening of said first partition.

95. The assembly of claim 89, wherein said second partition comprises at least one opening and at least one side wall having a first end and a second end, wherein said first end has a first dimension and said second end has a second dimension, and wherein said second partition comprises a first opening at said first end and a second opening at said second end.

96. The assembly of claim 95, wherein said seal is in contact with said first opening of said second partition.

97. The assembly of claim 96, further comprising an additional seal in contact with said second opening of said second partition, wherein said additional seal is configured to seal said second opening of said second partition.

98. The assembly of claim 89, wherein said seal is a film.

99. The assembly of claim 98, wherein said seal comprises aluminum.

100. The assembly of claim 89, wherein said seal is an adhesive seal.

101. The assembly of claim 100, wherein said adhesive seal comprises a double-sided adhesive configured to couple said first substrate to said second substrate.

102. The assembly of claim 89, wherein said first substrate and said second substrate comprise mechanical fasteners configured to couple said first substrate to said second substrate.

103. An assembly for storing reagents, comprising:
a substrate comprising a partition;
a first layer of frozen material disposed in said partition, wherein said first layer of frozen material comprises a first reagent; and
a second layer of frozen material disposed adjacent to said first layer of frozen material in said partition, wherein said second layer of frozen material comprises a second reagent different from said first reagent,
and wherein said partition is configured to permit said first reagent and said second reagent to mix upon melting of said first layer of frozen material and said second layer of frozen material.

104. The assembly of claim 103, wherein said substrate comprises a plurality of partitions comprising said partition.

105. The assembly of claim 103, wherein said partition comprises at least one side wall having a first end and a second end and an opening disposed adjacent to said first end or said second end, and a seal disposed in contact with said opening and configured to seal said partition.

106. The assembly of claim 103, further comprising a third layer of frozen material disposed adjacent to said second layer of frozen material, wherein said third layer of frozen material comprises a third reagent different from said first reagent and said second reagent.

107. The assembly of claim 103, wherein said first reagent or said second reagent comprises an enzyme.

108. The method of claim 103, wherein said first reagent or said second reagent comprises one or more components selected from the group consisting of a cofactor, a substrate, a buffer, and combinations thereof.
